(19) United States
(12) Patent Application Publication
(10) Pub. No.: US 2002/0136368 A1
(43) Pub. Date: Sep. 26, 2002

(54) Method and apparatus for message notification

(75) Inventors: Ippo Aoki, Tokyo (JP); Shinya Takahashi, Tokyo (JP); Takashi Kouno, Tokyo (JP)

Correspondence Address: BANNER & WITCOFF, 1001 G STREET N W, SUITE 1100, WASHINGTON, DC, 20001, US

(73) Assignee: Kabushiki Kaisha Toshiba, Tokyo (JP)

(21) Appl. No.: 10/105,940

(22) Filed: Mar. 26, 2002

(30) Foreign Application Priority Data
Mar. 26, 2001 (JP) P2001-87047

(51) Int. Cl. H04Q 7/20; H04M 1/64; H04M 11/10

(52) U.S. Cl. 379/88.12; 455/412; 455/466

(57) ABSTRACT

It is an object of the present invention to provide a communication apparatus provided with a control function that makes it possible to notify a meaning of a text message prior to checking the content of the received text message. The control unit 40 has a detector 401 and a selector 402. The detector 401 detects at least one character string in a received text message. The selector 402 selects a message notifying operation stored in memory 44 on basis of the detected character string.

### RELATED APPLICATION INFORMATION

This application claims priority under 35 U.S.C. § 119 to Japanese patent application P2000-87047 filed on Mar. 26, 2001, the entire content of which is incorporated herein by reference.

### FIELD OF THE INVENTION

The present invention relates to a communication apparatus, particularly to a communication apparatus with an improved text message receiving function.

### DESCRIPTION OF THE RELATED ART

Some mobile communication systems, for example, a cellular phone system, already have a text message service, for example, short message service (SMS), two-way message service or Electronic mail (E-mail) service.

In these text message services, a message center in the mobile communication system can store a text message addressed to a subscriber, for example, a cellular phone in the mobile communication system.

Receiving a text message addressed to a subscriber in the mobile communication system, the text message center stores the text message. After storing, the message center transmits information about a sender and a title of the text message to the addressed cellular phone. The “sender” of the text message refers to, for example, a device that transmits message, such as a text message, addressed to the subscriber.

The addressed cellular phone then displays the information about the sender and title. The subscriber of the addressed cellular phone can then request the text message center to send the full content of the text message by checking the information on the display. After receiving the request, the text message center in the mobile communication system transmits the content of the text message to the requesting cellular phone.

The above mobile communication system that transmits information about a sender and a title of the addressed text message to a cellular phone does not allow the subscriber of the cellular phone to understand the meaning of the full content of text message.

Therefore, the subscriber of the cellular phone usually has to request the text message center to send the remaining content of a text message and check the transmitted content of the text message on the display before understanding the meaning of the content of the text message.

As explained above, though a conventional communication apparatus sometimes can allow the subscriber to understand the content of the sending text message by checking only the title and sender, the conventional communication apparatus almost always has to request the text message center to send the content of a text message and check the sent content on the display before understanding the actual meaning of the content of text message.

In particular, in order to immediately understand the meaning of the text message, the subscriber has to receive the content of the text message from the text message center and display the received content. These operations can be troublesome.

### SUMMARY

It is an object of the present invention to provide a communication apparatus provided with a control function that makes it possible to notify a meaning of a text message prior to checking the content of the received text message.

In some embodiments of the present invention, the above object is achieved by a communication apparatus comprising: a memory configured to store a table identifying one or more character strings; and identification of one or more message notifying operations corresponding to said character strings; a receiver configured to receive a message; a detector configured to detect one or more of said character strings in the received text message; and a selector configured to select one or more of the message notifying operations based on the detected character string.

In some embodiments of the present invention, the above object is also achieved by a method in a communication apparatus, the method comprising: storing an identification of a message notifying operation corresponding to a character string; receiving a text message; detecting said character string in a received text message; and selecting the message notifying operation for execution based on the detected character string.

In the present invention, the above object is also achieved by a control unit in a communication apparatus that receives a message and stores a message notifying operation corresponding to a character string in the message, the control unit comprising: a detector configured to detect said character string in a received message; and a selector configured to select the message notifying operation based on the detected character string.

### BRIEF DESCRIPTION OF THE DRAWINGS

FIG. 1 is a block diagram showing a configuration of an embodiment of a communication apparatus according to the present invention;

FIG. 2 is a list showing character strings and items related thereto stored in a memory 44 in the communication apparatus in one embodiment according to the present invention;

FIG. 3 is a block diagram showing a configuration of one embodiment of a control unit 44 according to the present invention;

FIG. 4 is a flow chart showing a control process of the communication apparatus in one embodiment according to the present invention; and

FIG. 5 is a flow chart showing another control process of the communication apparatus in an embodiment according to the present invention.

### DETAILED DESCRIPTION OF THE EMBODIMENTS

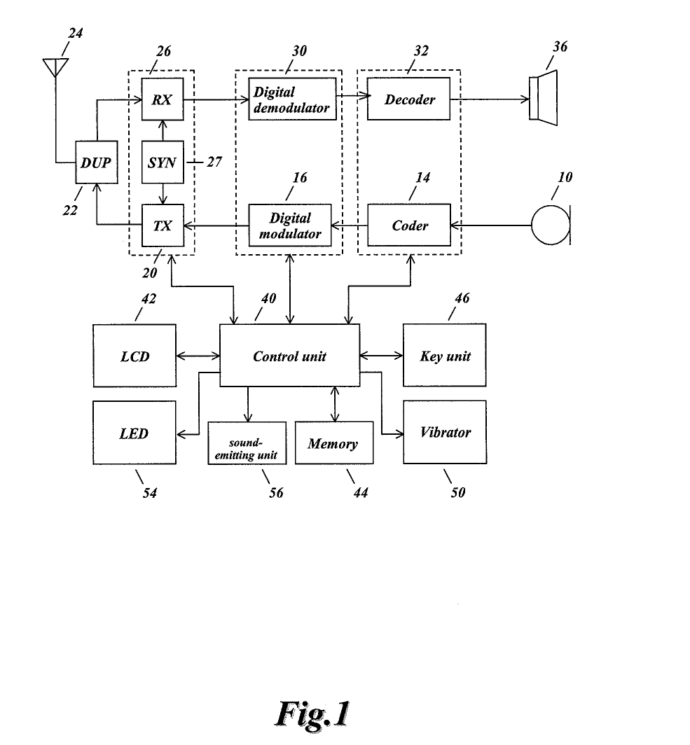

Various illustrative embodiments will be described with reference to the drawings. FIG. 1 is a functional block diagram of an exemplary communication apparatus according to at least one aspect of the invention.

The communication apparatus includes a microphone 10 for receiving sound, such as a user's voice, and for converting the sound to a voice signal. The voice signal is transmitted from the microphone 10 and digitized in a coder 14 before being compressed.

A digital modulator 16 modulates the compressed signal. A radio-transmitting unit (TX) 20 converts the modulated and compressed signal to a high frequency signal by a local signal outputted from a synthesizer (SYN) 27, and amplifies it to a specified power level for transmission The amplified signal is supplied to an antenna 24 by a duplexer (DUP) 22. The signal then is transmitted as a radio high frequency signal via the antenna 24. The high frequency signal may be used to allow the apparatus to communicate with any communications network, such as a telephone network, wireless telephone network, cellular network, the Internet, a local access network, etc. In some embodiments, the high frequency signal may be used to allow the device to communicate with a base station in a cellular phone or pager network.

To receive, at antenna 24, a radio signal with a high frequency transmitted from a base station while the apparatus 1 is transmitting another radio signal, the apparatus 1 includes a duplexer 22.

The duplexer 22 allows the transmitted signal from the TX 20 to reach the antenna 24 while allowing the received radio signal to reach a radio-receiving unit (RX) 26.

The RX 26 amplifies the received high frequency signal and converts the amplified signal to a base band signal in accordance with a local signal generated by SYN 27.

The converted base band signal then is inputted to a digital demodulator 30 for demodulation. The demodulated signal then is inputted to a decoder 32.

The decoder 32 decodes the demodulated signal and converts the decoded signal to an analog voice signal. The analog voice signal then is outputted from a speaker 36, earphone, or other similar output device.

A control unit 40 is coupled to a Liquid Crystal Display (LCD) 42 or other display device, a memory 44, and/or a key unit 46 to allow the user to input information using one or more buttons, keys, touch-sensitive surfaces, or other similar input devices.

The control unit 40 may be a single unit, or may be composed of multiple physically and/or logically separate elements.

Similarly, the various other devices, units or parts depicted in the figures and described herein may each be implemented as single individual devices or components, or alternatively, any of them may be composed of multiple components. Additionally, two or more depicted devices and components may be combined as part of a single unit.

The control unit 40 is further coupled to a vibrator 50. The vibrator 50 may cause some or all of the apparatus 1 to vibrate.

The control unit 40 is further coupled to a sound-emitting unit 56. The sound-emitting unit 56 is a speaker, piezoelectric element, or any other device that generates or otherwise emits sound.

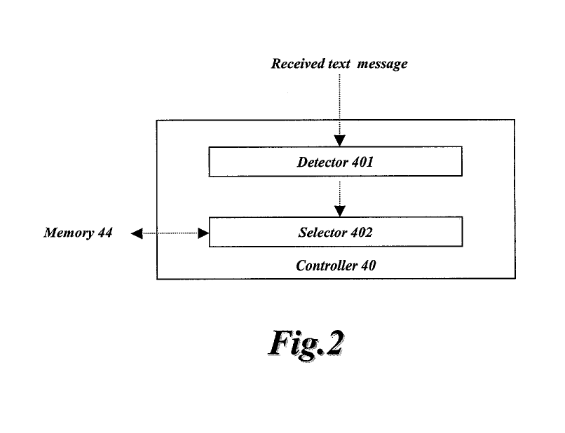

As shown in FIG. 2, the control unit 40 has a detector 401 and a selector 402. The detector 401 detects at least one character string in a received text message. The selector 402 selects a message notifying operation stored in memory 44 on basis of the detected character string. In one embodiment, detector 401 and selector 402 may be software code executable by the controller 40. The code may be part of a single computer software module, or alternatively, they may be implemented as separate software modules. In a further alternative embodiment, the detector 401 and/or selector 402 may be implemented using hardware circuitry designed to detect predefined strings and/or data in a message.

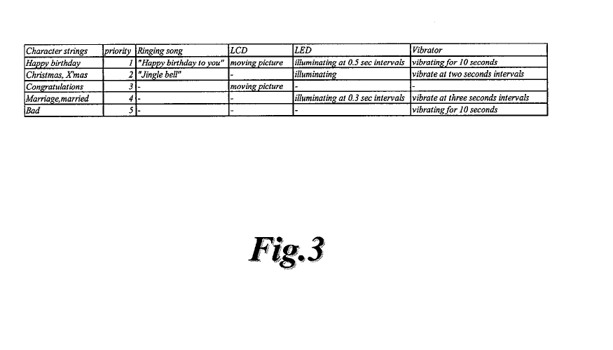

FIG. 3 is a table showing an example of items stored in the memory 44. These items identify a number of character string(s) and/or codes that the detector 401 searches for in a message, and 1 or more results to be taken if the string and/or code is found in the message. The various strings and/or codes may be listed with a priority, an identification of an audible tone or song, an identification of an action to be taken by a display device (such as the display of one or more images on an LCD or LED display), an identification of action to be taken by a vibrating element, or any other responsive action that may be taken by the user's device.

The mobile communication apparatus shown in FIG. 1 carries out the operation related to the received character strings in the text message. The operation is stored in this table of the memory 44.

For example, when the mobile communication apparatus receives a text message including the character string “Happy birthday”, the mobile communication apparatus carries out the operation to ring a song “Happy birthday to you” by the sound-emitting unit 56.

In addition, the operation can include that of displaying a picture on the LCD 42, illuminating the LED 54 at periodic intervals or in a predetermined sequence, and/or vibrating the vibrator 50 for a predetermined amount of time, such as 10 seconds.

For example, when the mobile communication apparatus receives a text message including the character string “Christmas” or “X'mas”, the mobile communication apparatus carries out the operation to ring a song “Jingle bell” by the sound emitting unit 56, illuminate the LED 54 and vibrate the vibrator 50 at two second intervals.

For another example, when the mobile communication apparatus receives a text message including the character string “Congratulations”, the mobile communication apparatus carries out the operation to display a picture on the LCD 42 and illuminate the LED 54.

For another example, when the mobile communication apparatus receives a text message including the character string “Marriage” or “married”, the mobile communication apparatus carries out the operation to illuminate the LED 54 at periodic intervals or in a predetermined sequence and vibrate the vibrator 50 at three-second intervals.

For another example, when the mobile communication apparatus receives a text message including the character string “Bad”, the mobile communication apparatus carries out the operation to vibrate the vibrator 50 for 10 an amount of time, such as 10 seconds.

Any number of responses is possible, and these responses may help convey the actual meaning of a message to the user.

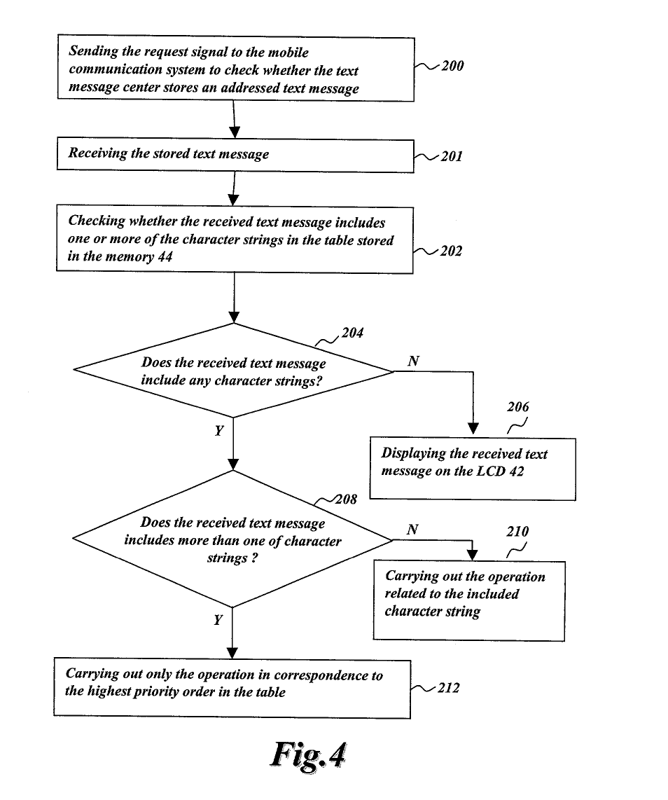

FIG. 4 is a flow chart showing a control function in one embodiment according to the present invention.

When the control unit 40 accepts the request to check whether the text message center stores an addressed text message by user's operation, the control unit 40 transmits a request signal to a mobile communication system (200). After receiving the request signal, the mobile communication system checks whether the text message center stores a text message addressed to the requesting apparatus.

If the text message center stores a text message addressed to the requesting apparatus, the mobile communication system transmits the stored text message to the requesting apparatus. The control unit 40 in the apparatus receives the stored text message (201).

After receiving the text message, the control unit 40 checks whether the received text message includes one or more of the character strings in the table stored in the memory 44 (202).

When the received text message does not include any character strings (204), the control unit 40 displays the received text message on the LCD 42 (206).

When the received text message includes one of character strings (204, 208), the control unit 40 carries out the operation related to the included character string (210).

When the received text message includes one or more character strings (204, 208), the control unit 40 carries out only the operation in correspondence to the highest priority order indicated in the table (212).

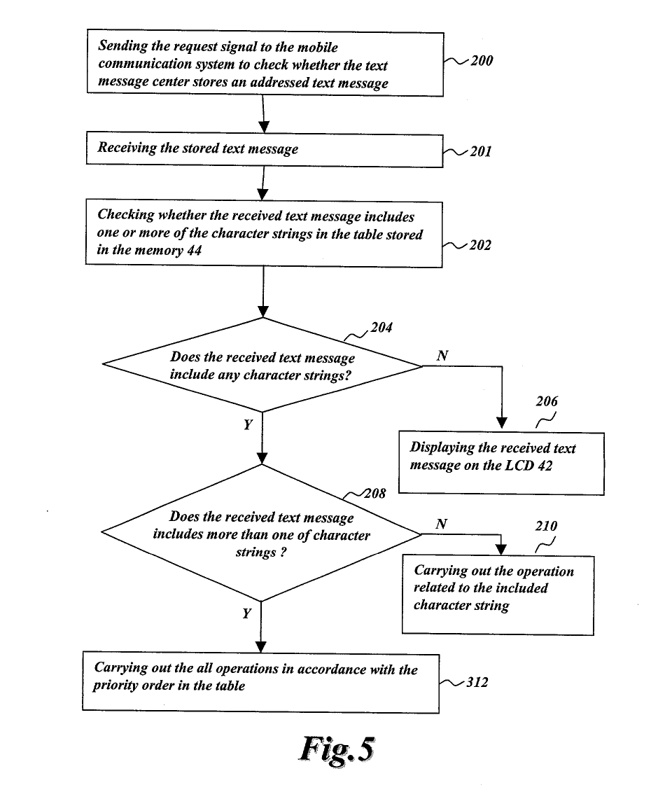

FIG. 5 shows another embodiment. When the received text message includes one or more character strings (204, 208), the control unit 40 can carry out all operations in accordance with the priority in the table (312).

In some alternative embodiments, the received text message may include one or more of the targeted character strings, the control unit 40 can carry out all of the listed operations sequentially in accordance with the order in which the character strings appear in the received text message. For example, a string or code appearing near the beginning of a message may have its corresponding action carried out before that of a string or code appearing nears the end of a message. Alternatively, the user's device may carry out the various operations based on the priority information stored in the table. For example, and as shown in the FIG. 3 example, the table might indicate that responding to the string “Happy birthday” is of a higher priority than responding to the string “Christmas.” In such an example, if a message contained both strings, the device would play “Happy birthday to you” before playing “Jingle bell.”

In some embodiments, the device might only respond to the highest priority string. Such an embodiment would simplify the amount of activity taken by the device. In other embodiments, the lower-priority responses are simply carried out after the higher priority ones, allowing all responsive actions to be taken.

In some embodiments, the received text message itself may specify the priority to carry out its corresponding operation. For example, the message may indicate that its strings are to be given a higher priority order number than otherwise specified by the user's device.

The received text message may also use one or more predefined codes (e.g., an asterisk “*”) that identify a string. Using such a shortened code may simplify the search process.

Furthermore, the user of the apparatus can select that all operations stored in the table may be carried out or that some of operations stored in the table may be carried out.

Step 200 in FIG. 4 or FIG. 5 shows the step in which a mobile communication apparatus transmits a request signal to the mobile communication system to check whether a text message center stores a text message addressed to the apparatus. In this case, the text message center in the mobile communication system stores the text message in advance.

However, this invention is not limited to this process. Alternative embodiments can include a process in which one mobile communication apparatus directly transmits a text message to another mobile communication apparatus over the mobile communication system. In this case, the text message center in the mobile communication system does not have to store the text message. Furthermore, the mobile communication apparatus receives the text message after receiving an incoming message call.

The text message in this invention can be E-mail, text message in Short Message Service (SMS) or two-way message service or other form of electronic message containing one ore more characters (e.g. bits, digits, numbers, letters, codes, symbols, etc).

This discussion above uses the term mobile communication apparatus, which may be any type of portable communication device, such as cellular phone, pager, Personal Data Assistant (PDA). However, this invention is not limited to a mobile communication apparatus. For example, this invention can be adapted to any communication apparatus being capable of receiving a message.

As explained above, one of embodiment of the present invention includes a communication apparatus having a control function that makes it possible to notify a user of a meaning of a text message prior to actually transmitting and displaying the full content of the received text message.

While the present invention has been particularly shown and described with reference to the preferred embodiment thereof, it will be understood by those skilled in the art that the foregoing and other changes in form and details can be made therein without departing from the spirit and scope of the present invention.

what is claimed is:

1. A communication apparatus comprising:
a memory configured to store a table identifying one or more character strings; and identification of one or more message notifying operations corresponding to said character strings;
a receiver configured to receive a message;
a detector configured to detect one or more of said character strings in the received message; and
a selector configured to select one or more of the message notifying operations based on the detected character string.

2. The communication apparatus according to claim 1, further comprising a controller configured to control the apparatus, wherein the detector and the selector are software instructions executed by the controller.

3. The communication apparatus according to claim 1, further comprising a transmitter configured to transmit a request to a communications network to check whether said network stores a message for said apparatus.

4. The communication apparatus according to claim 1, wherein the message notifying operation is ringing a tone related to a character string in the received message.

5. The communication apparatus according to claim 4, wherein the tone conveys the detailed meaning of a character string in the received message.

6. The communication apparatus according to claim 1, wherein the message notifying operation is vibration related to a character string in the received message.

7. The communication apparatus according to claim 6, wherein the vibration conveys the detailed meaning of a character string in the received message.

8. The communication apparatus according to claim 1, wherein the message notifying operation includes the display of one or more images related to a character string in the received message.

9. The communication apparatus according to claim 8, wherein the one or more images convey the detailed meaning of a character string in the received message.

10. The communication apparatus according to claim 1, wherein the memory stores priority information corresponding to the one or more message notifying operations.

11. The communication apparatus according to claim 10, wherein the selector selects a message notifying operation in accordance with the priority information.

12. The communication apparatus according to claim 11, wherein the message notifying operations are performed sequentially based on the priority information.

13. The communication apparatus according to claim 11, wherein the message notifying operations having the same priority are performed simultaneously.

14. A communication apparatus comprising:
a receiver configured to receive a message;
a memory configured to store a message notifying operation corresponding to a character string in a message; and
a controller comprising;
a detector configured to detect a character string in the received message; and
a selector configured to select the message notifying operation based on the detected character string.

15. A method in a communication apparatus, the method comprising:
storing an identification of a message notifying operation corresponding to a character string;
receiving a text message;
detecting said character string in a received text message; and
selecting the message notifying operation for execution based on the detected character string.

16. The method according to claim 15, wherein the message notifying operation is ringing a tone related to a character string in the received text message.

17. The method according to claim 16, wherein the tone conveys the detailed meaning of a character string in the received text message.

18. The method according to claim 15, wherein the message notifying operation is vibration related to a character string in the received text message.

19. The method according to claim 18, wherein the vibration conveys the detailed meaning of a character string in the received text message.

20. The method according to claim 15, wherein the message notifying operation includes displaying one or more images related to a character string in the received text message.

21. The method according to claim 20, wherein the displayed one or more images conveys the detailed meaning of a character string in the received text message.

22. The method according to claim 15, further including the step of storing priority information corresponding to the message notifying operation.

23. The method according to claim 22, further including the step of selecting a message notifying operation in accordance with the priority information.

24. The method according to claim 23, further selecting all message notifying operations based on the priority information and performing the selected message notifying operations sequentially in accordance with their priority.

25. The method according to claim 23, further selecting message notifying operations based on the priority information, and when two of said message notifying operations have the same priority, performing the selected message notifying operations at the same time.

26. A method in a communication apparatus comprising:
storing a message notifying operation corresponding to a character string in a text message;
receiving a text message; and
detecting a character string in the received text message; and
selecting the message notifying operation based on the detected character string.

27. A control unit in a communication apparatus that receives a message and stores a message notifying operation corresponding to a character string in the message, the control unit comprising:
a detector configured to detect said character string in a received message; and
a selector configured to select the message notifying operation based on the detected character string.

28. The control unit according to claim 27, wherein the message notifying operation is ringing a tone.

29. The control unit according to claim 27, wherein the tone conveys the detailed meaning of a character string in the received message.

30. The control unit according to claim 27, wherein the message notifying operation is vibration.

31. The control unit according to claim 30, wherein the vibration conveys the detailed meaning of a character string in the received message.

32. The control unit according to claim 27, wherein the message notifying operation is displaying one or more images.

33. The control unit according to claim 32, wherein the one or more images convey the detailed meaning of a character string in the received message.

34. The control unit according to claim 27, wherein the memory stores priority information corresponding to the message notifying operation.

35. The control unit according to claim 34, wherein the selector selects a message notifying operation in accordance with the priority information.

36. The communication apparatus according to claim 35, wherein the selected message notifying operations are performed sequentially based on the priority information.

37. The communication apparatus according to claim 35, wherein the selected message notifying operations having the same priority are performed simultaneously.
